(19) United States
(12) Patent Application Publication
(10) Pub. No.: US 2014/0156554 A1
(43) Pub. Date: Jun. 5, 2014

(54) APPARATUS AND METHOD FOR THE CATEGORIZATION OF SCANNED INFORMATION, IN PARTICULAR THE MATURITY LEVEL OF LITERATURE DISTRIBUTED TO CONSUMERS, TO EXPRESS THE CATEGORIZATIONS TO CONSUMERS

(71) Applicant: George Stewart Payne IV, Cincinnati, OH (US)

(72) Inventor: George Stewart Payne, IV, Cincinnati, OH (US)

(21) Appl. No.: 13/850,556

(22) Filed: Mar. 26, 2013

Related U.S. Application Data
(60) Provisional application No. 61/617,141, filed on Mar. 29, 2012.

(51) Int. Cl. G06Q 30/02

(52) U.S. Cl. CPC G06Q 30/0282
USPC 705/347

(57) ABSTRACT

Apparatus and a method are disclosed for the assignment of a maturity rating on a piece of literature, namely a book, which requires no extra time or energy from those involved in the process, performed by an original process of assigning a numerical value to portions of a book's literature, which is carried out either by a software apparatus or method involving human involvement, with ratings being obtained under license and recorded in a central database, and displaying that book's category of maturity level to the public during the process of offering a book for consumption in one form or another, in an expression of an already created piece of literature pertaining to only English and not any spin-off language contained within. The rating process uses an established curriculum. Ratings are solely used for advantages to all of those involved.

### BACKGROUND

Literature has the same ability to portray content of various maturity levels to audiences as all other forms of media and entertainment. The reason it has never been categorized based on this fact by a third party is due to the unique dynamics the process of rating literature requires concerning time and ability. This is also the reason why a thirds party needs to be involved in this process similar to other industries such as film and music. Being cost effective, well planned, and accurate makes this databank and search engine oriented apparatus an appropriate process for this new market's successful impact on society. What separates this process from the non profit and lobbying group style structure of the rating authorities of the other industries is that this is an original process and it's sole intention is to make more money than books without ratings; as opposed to the sole intention of keeping an industry united.

During the process of distributing books to consumers, a store uses this system to present more information to the consumer. The process is to give books audience maturity ratings based on the subject matter, language, influence, and content in the books. This has never been done before due to a variety of reasons, the least of which not being an inability to figure out how to rate a book. In the sense of communication, the database, a distributor, a publisher, and one customer using the same agreed upon maturity rating category for the book(s) distributed: serve as an agreement of commonality, meaning the categories of maturity level are not duplicated, imitated, overlapping or misleading to customers.

The process of presenting books and distributing books to audiences has, over the years, been so vast in size and scope that many innovations have spurred off of the process. The way audiences read books has changed dramatically due to technology and improvements to existing methods. Some old methods have used protected systems and processes that still exist today, such as the Dewey Decimal System in mostly every single library in existence. Some new methods have created new protected systems, such as patents involved with stores that are websites. This new system is both an improvement on literature distribution and also a comparison to other industries.

Comparing the act of assigning maturity ratings to films and to books is relatively precise in terms. Using the act of rating literature as an argument to prove rating films is patentable is literally the same thing as saying “reading a book for this reason is original, so watching a movie for the same reason is also original.” There is nothing original about reading a book, or watching a movie, regardless of the reasons. However, using this original process is a complex, multi-layered cognitive activity that is performed according to an original curriculum, criteria, and set of rules by either a software apparatus, an individual who holds the right to access this patent's processes, or both a software apparatus and an individual, which yields an original end result—a rated book.

Many past innovations come close to this process either by structure or reason, but none combine both exactly, making rating books for maturity levels a brand new process and action being performed by a new apparatus. One example of a similar structure is the Dewey Decimal System, which categorizes books by subject matter. This is the same process on the exterior as labeling books for maturity rating. However, giving books maturity ratings does not categorize them, because a group of books having the same rating are not grouped together on purpose the way they would be if they had the same subject matter, but rather, continue to be grouped individually among other books with similar subject matter. One library even designated a few shelves to the heading ‘adult’, however, it was used as a genre generalization and not as an indication of specifically measured content matters in the books. Also, this heading, ‘adult’, proves that there is no negative connotation for the representation of an author's work by naming the most common maturity level category ‘Adult’.

An example of a past innovation that has the same reason, but not the same structure, would be the process of selling books that are considered pornography, by giving them an unofficial ‘XXX’ rating. However, this is not the same structure because the rating is just a commonly accepted label in society that applies to all media containing other humans or animals being watched in sexual activities, rather than a rating designed for books by structure.

This approach highlights how even in non fiction writing, there are subtle influences that impact the reader and should be rated accordingly for the benefit of both reader and author. We are taking a dirty, unpleasant approach concerning subject matter, but taking a positive, reassuring approach concerning the impact on the reader and the momentum they take with them into their lives after reading. The opposite would be to use very clean, possibly even family oriented subject matter and present it passive aggressively to bully the reader into feeling dis-empowered, belittled, compared and faithless. The latter momentum might be an empty feeling and disappointment in others.

The process of rating literature for audience maturity ratings is presented to only further explain the book to the audience, and this process is only using 3 main categories, along with 2 categories for extremely intense literature and 1 category for children. The process is a search engine that combines key words, key phrases, and definitions found in the text to assign a book a numerical value, which falls in a rating category assigned to that range of numbers. The inventor discovered a part of the process which has been the main barrier preventing others in the industry from figuring this process out: the process measures the exact nearness one word of a dark or evil subject is from a word of a light or joyful subject in a numerical value. That is how evil, sadomasochistic, and intimidating themes are shown in mature literature which uses very acceptable language. That is how this business will show the reader the difference in the above mentioned reader impacts, which used this write up as an example. Also, since there are only three main categories for audience maturity level, the exact themes will only matter to the point where the reader needs to know how to approach the book. This apparatus is not attempting to dissect the exact reasons for different themes.

Many main stream books are clean cut in presentation, innocent in plot, and contain the word ‘shift’ in the first paragraph. Other books are clean cut and straight laced in language, and use overkill to belittle joys in life and make the reader feel intimidated or depressed after reading it. Some books simply use a more liberal approach to entertainment and would benefit by a maturity rating aiming the book directly at a specific target audience. Out of the many reasons why giving books maturity ratings is needed, the most powerful is an ability of the process to combine increasing profits for the entire industry by attracting more people to books, with increasing the overall maturity level of society. An increase in maturity level requires no need.

The ability of literature to give in-depth and detailed accounts of the various psychological elements involved with disturbing subject matter such as violence and certain sexual themes makes the need for this original process of rating literature more pressing than the need for rating other forms of entertainment—a child, tween or teen can see images just as violent as any horror movie on the front cover of a popular newspaper covering war in the Middle East. These various psychological elements subconsciously impacts a child, tween, teen and even an adult's understanding and interpretation of several portions of their environment.

However, allowing literature to be rated also allows authors to explore more intense subject matters than they are currently able to, due to the ability to neglect audiences that are irrelevant to their piece of art. A distributor assigning a rating to a book, much in the same way that they assign a price, has no influence towards authors' creative processes that do not already exist in various other forms of demand by publishers, consumers, or social (group) judgments and does not give any type of restriction to consumption or shed any type of negative light on the source of the entertainment that is not currently being done in other forms of entertainment. A book distributor has the right to assign the book a price and genre, and therefore would not be breaking any type of copyright, legal ownership, or contractual laws by also assigning that same book a non-judgmental and unbiased maturity rating, regardless of an author's personal emotions towards the use of this apparatus, databank, and process in order to do so. In fact, the choice to not distribute with a store that uses maturity ratings by an author may be considered discrimination; if the author did choose to demonstrate to their readers a lack of responsibility for the general well-fare and safety of the general public to which they write, taint their reputation as stubborn and unreasonable, and seclude themselves into a small minority of the general public for readership, inevitably initiating the beginning of the end for their careers.

Rather than being an almighty force in what is allowed to be said and what isn't when it is written in a book, and taking away speech freedom, and slandering authors whose books are mature in content, content is based on the expression of the artist as asked for by their specific audience rather than being based on fear or probabilities when the distributor has the ability to assign their media a maturity level, because books no longer have to appeal to all ranges of readers.

Your favorite rock star's autobiography wasn't written to your five year old daughter, and you wouldn't enjoy it if it was.

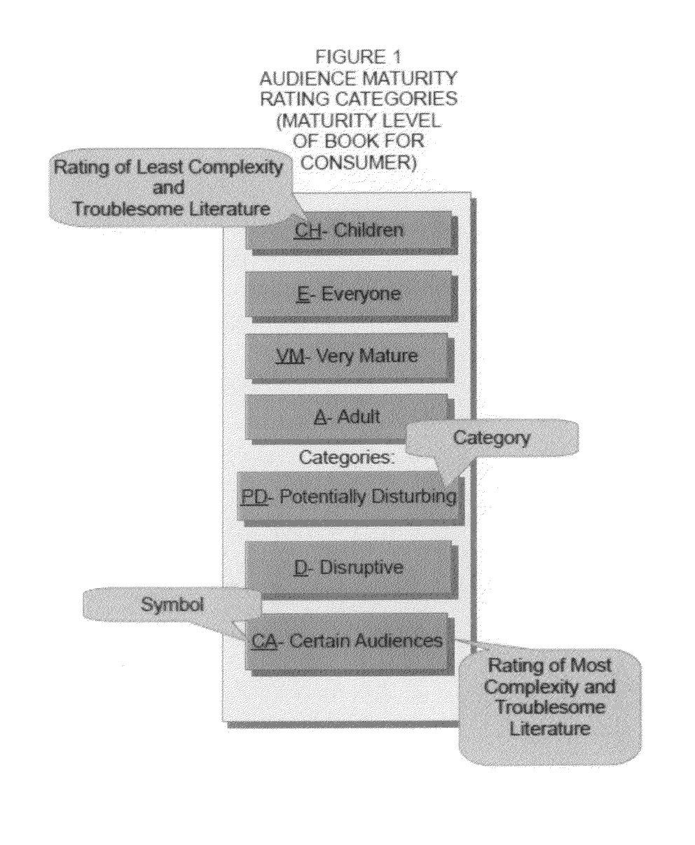

The audience maturity rating categories for distributed literature are as follows: (FIG. 1):

1. CH—Children

2. E—Everyone

3. VM—Very Mature

4. A—Adult

5. PD—Potentially Disturbing

6. D—Disruptive

7. CA—Certain audiences

### SUMMARY

It is the direct objective of this invention to assign literature written for entertainment purposes, and other possible purposes, mainly books, each their own maturity rating as to inform the consumers of the various types of content of said books based on assigning each book to a general category. This is performed by a software apparatus which carries out the entire process by itself on multiple books at a time, or by an individual who utilizes the methods described in this patent after being assigned the privilege to do so via a licensing process.

In accordance with each book given a maturity rating, the rating given has a media for communicating the rating directly to the consumer of the book during the consumer shopping for the book, either in a store of books from a website, with a media adjacent to the book in it's listing in the website library, or in a brick and mortar book store somewhere on the book cover if published physically; which is rendered by original software processes and original book review processes by professionals licensed by the company to hold the legal authority to give a book a maturity rating used for public distribution; and is recorded by the business for a history list of every distributed book rating owned by the business.

### Advantages

Accordingly several advantages of one or more aspects are as follows: to provide the public with more in-depth information about a book before they choose to read it so that they know what to expect concerning the book content, supply the public with ratings for literature, with a rating being assigned to each book by an original process either carried out by a software apparatus or individual, with very simple and easy to understand graphics communicating the book's rating directly to the consumer in the book store, which makes the book industry a more lucrative industry than ever before, society more mature than without book ratings, and newness-readers, writing styles, author followings, industry community participation and events, and markets.

### DETAILED DESCRIPTION

In different diagrams, the same process is explained in a flow chart and/or a diagram of functions for each step in the process listed by the TITLE of each separate process.

The following TITLEs are represented in this order in the following drawings for these processes: TITLE I: Overall Process For Software Rating System; TITLE II: Overall Process For Rating System Performed During the Publishing Process; TITLE III: Software Automatic Rating Process; TITLE IV: Graphics For Each Rating Category; TITLE V: Automatic Banking System Software to Take Commission on Books Sold With Rating; TITLE VI: Licensing Process; TITLE VII: Maturity Rating Review Checklist; TITLE VIII: Submission Process Involving Publisher, Licensed Individual, and Author For Rated Books; TITLE IX: Book Rating Recording Database System, Including Licensed Individual Database With Automatic Renewal Request; TITLE X: Overview of the Test Taken by Individual to be Granted A License For A Set Period of Time; TITLE XI: Process For Licensing Self Publishing Companies to Represent Their Customer's Books With Ratings; TITLE XII: Overview of Website Used For Rating Submission Process From Licensed Individual to the Business and For License Maintenance and Testing; TITLE XIII: Overview of Review Process Carried Out by Licensed Individual by An Established Format Used For Each Book; TITLE XIV: Process Overview of Paper Submissions of Book Ratings Received By Company In The Mail From Licensed Individual.

### FIG. 1 (ABOVE) PARTS

FIG. 1 is the list of maturity ratings used to rate books based on content for audience maturity rating and are communicated to the book buyer with a small graphic either listed next to the book details in an online store library or by a small graphic printed on the bottom right corner of the book's back cover if the book is sold as a physically printed book.

The categories chosen for maturity ratings are as follows; Category 1 (Part 1, FIG. 1) Children; Category 2 (Part 2, FIG. 1) Everyone; Category 3 (Part 3, FIG. 1) Very Mature; Category 4 (Part 4, FIG. 1) Adult; Category 5 (Part 5, FIG. 1) Potentially Disturbing; Category 6 (Part 6, FIG. 1) Disruptive; Category 7 (Part 7, FIG. 1) Certain Audiences. These categories were chosen for marketing purposes allowing ratings to encompass broad ranges of maturity due to the rating software's rating value system (A.9.2. and A.9.3.) having specific rules on what each category includes and can limit it due to the value system's orientation.

This is based on book marketability because the only categories that apply to most books sold are Category 2 (Part 2, FIG. 1), Category 3 (Part 3, FIG. 1), and Category 4 (Part 4, FIG. 1). That means book consumers have a choice of three maturity levels when purchasing a book from an online library or brick and mortar bookstore. The first option, rating Everyone, allows readers to choose literature that has no mature content whatsoever, and allows more educated guesses than based on book front and back covers and synopsis write ups. The second option, rating Very Mature allows consumers to purchase a book that might have a certain storyline style for a book of that genre and topic based on potential Very Mature style content. The third option, rating Adult, allows consumers to know what to expect as far as mature content from a book that might otherwise appear written like an Everyone rated book, based on reader impressions of front and back cover and book synopsis.

These “impact buying decisions” that the consumer is able to make from the information provided with a rating system are in this example more based on the book itself due to vagueness and in turn will increase book buying based on book details, rather than book appearance. This is due to the writing freedom allowed by fiction writing being rated for mature content. Authors will be able to target their audience more effectively, and readers will be able to choose authors more to their liking than if they weren't informed with maturity ratings.

The mature contents of each category of book rating are listed more thoroughly in the figures for TITLE III: Software Automatic Rating Process, which explains how each maturity level differs, ranges, and what they include. These same details for each category apply to the rating process use of categories in the process described in the figures for TITLE VII: Maturity Rating Review Checklist.

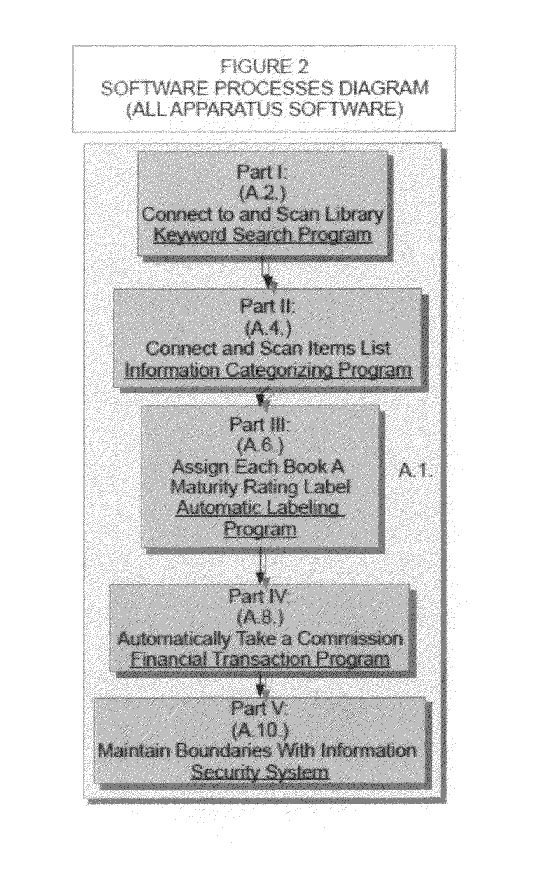

FIG. 2—A general software processes diagram which gives an overall view of the entire process of the apparatus assigning a book a maturity rating based on the book's content. This process is based on a five part procedure which includes every single aspect of the software working with an online store library to add the maturity rating graphics mentioned in FIG. 1 (above) to the library.

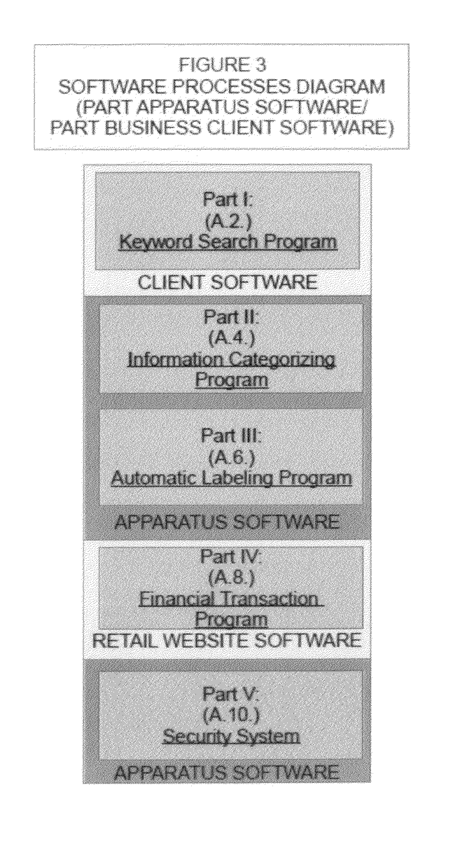

FIG. 3—The same process as FIG. 2, showing how some of the different parts may be completed by the apparatus combined with software provided by the online bookstore.

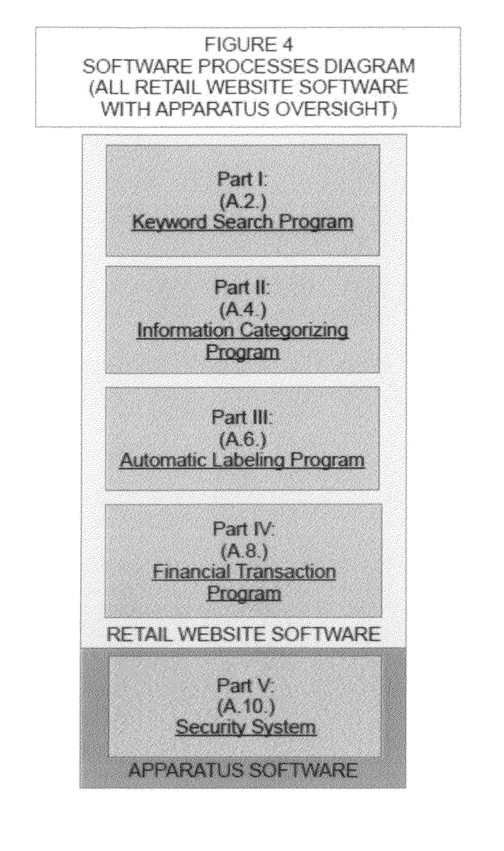

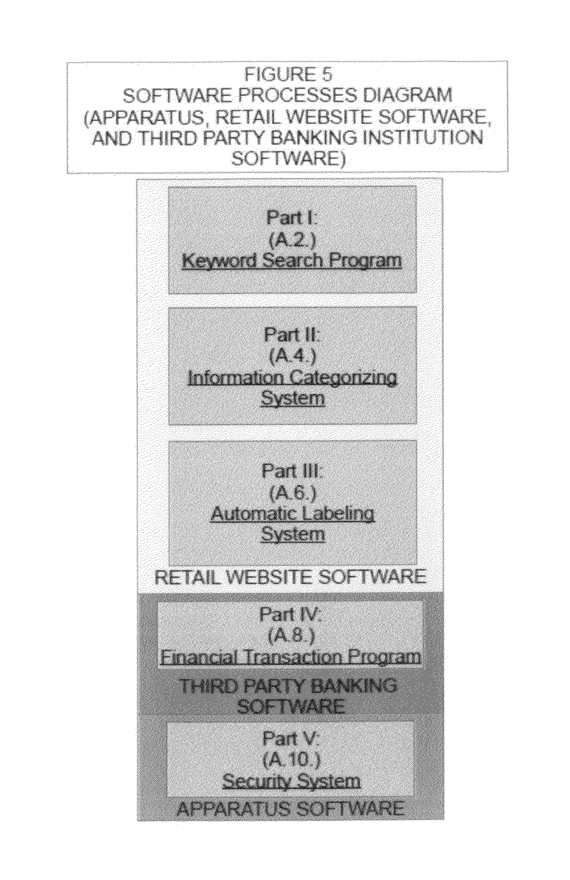

FIG. 4—The same process as FIG. 2, showing how the original process of rating books can be carried out all by software provided by the online bookstore that is overseen and reviewed by the apparatus previously mentioned.

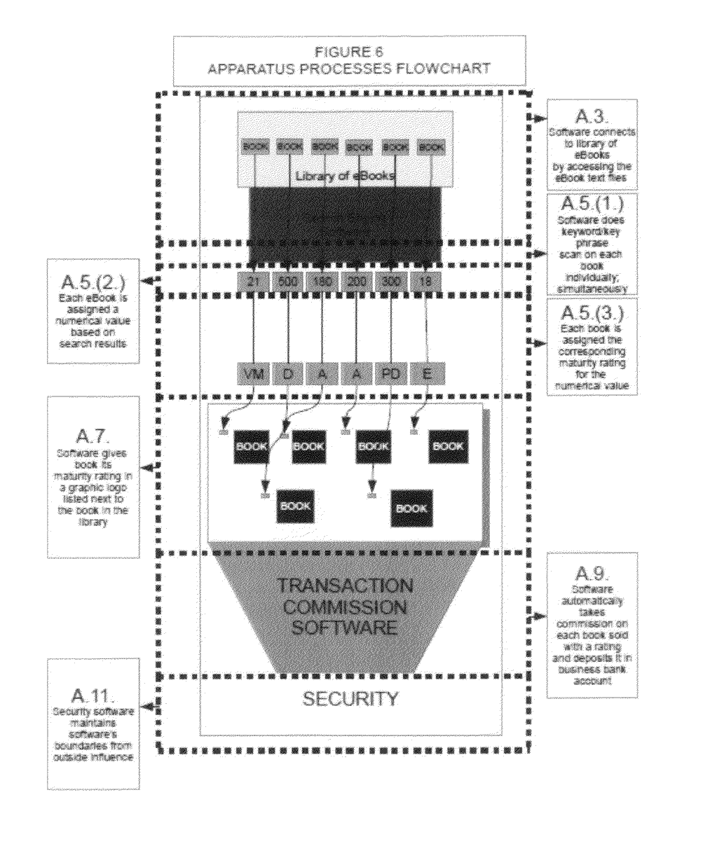

FIG. 5—The same process as FIG. 2, showing how the same original process may be carried out involving software provided by the online bookstore, a third party banking institution, and the apparatus previously mentioned.

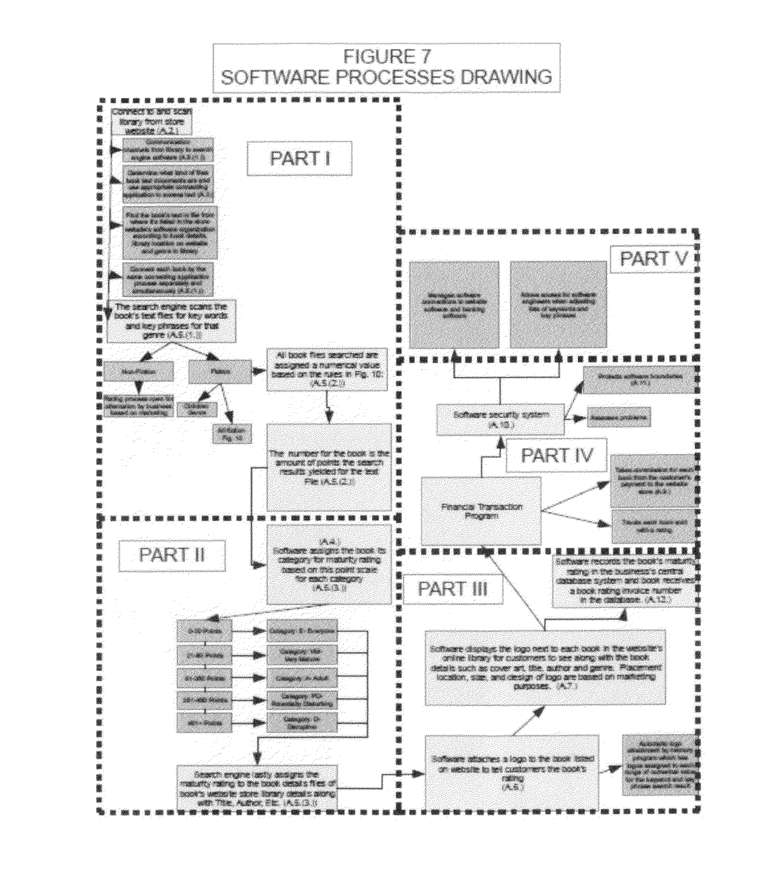

FIG. 6—A software processes flowchart, which shows the actions done by the apparatus in each of the 5 parts of the procedure by a step-by-step diagram along with an explanation of what each step is showing.

FIG. 7—The software process drawing, which shows the exact step-by-step decision making and actions the software does in exact detail when rating a book and assigning the book its maturity rating graphic in the online library; but also mentions that this entire process is done to multiple books simultaneously and automatically, rather than one after another. FIG. 7 shows the criteria used for each maturity rating, and how the maturity ratings range to encompass any type of mature content into only 3 main categories, therefore ruling out the possibility of technicalities of strange books causing inaccurate ratings. Also, only the English language is rated, not spinoff languages such as Ebonics, police code, or jargon. The ratings are accurate to the point of being the same rating achieved using software as would be achieved from a person reviewing it. The ratings are used for marketing purposes in order to increase profits for the bookstore.

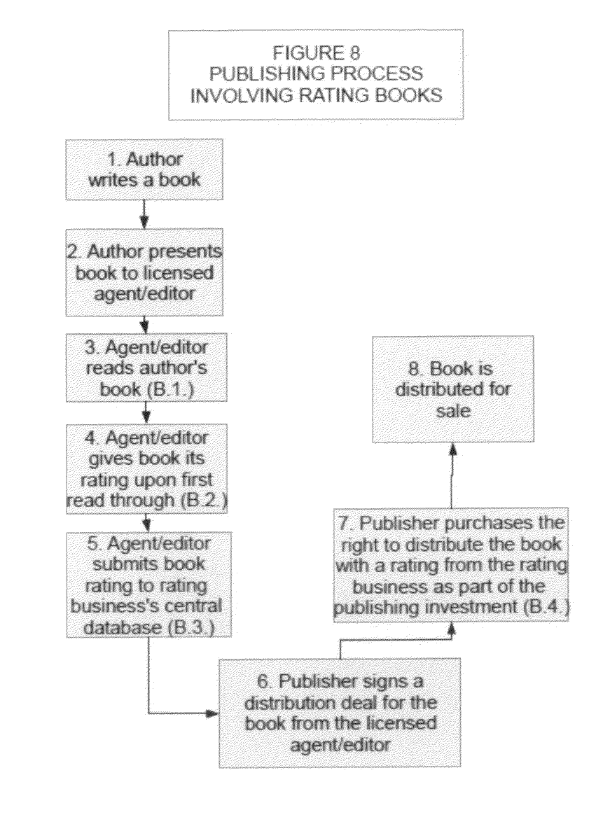

FIG. 8—The flow chart for the publishing process involving rating a book for maturity level. It shows each step in the publishing process of a book from step one through the step of rating the book to the last step of selling the book to customers.

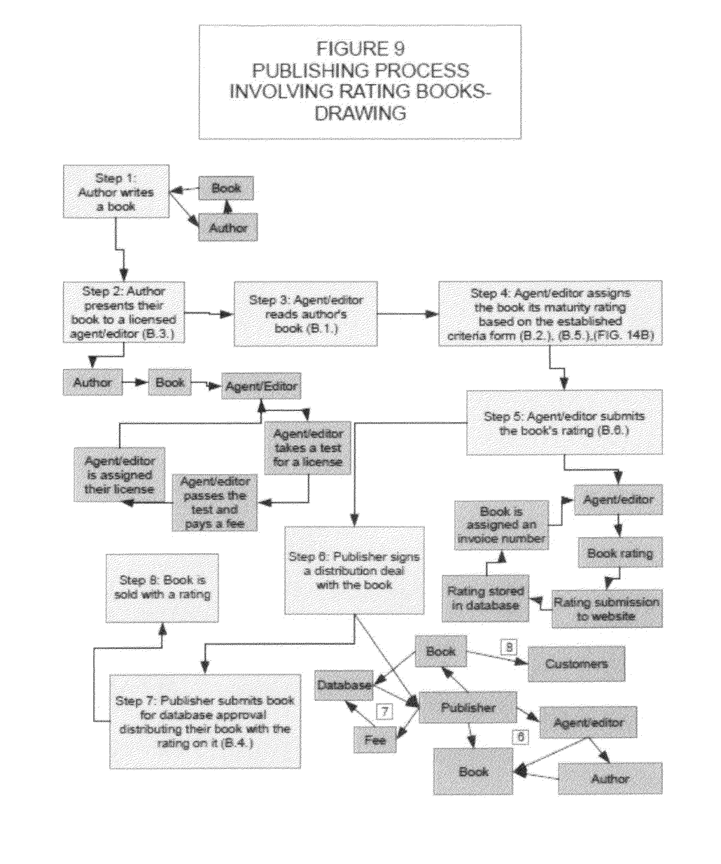

FIG. 9—The steps of FIG. 8 in further detail.

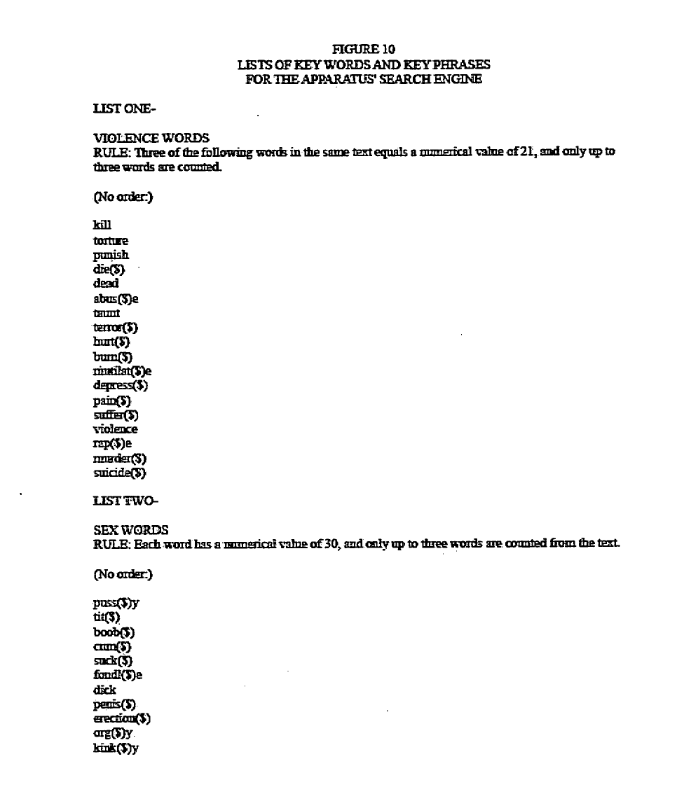

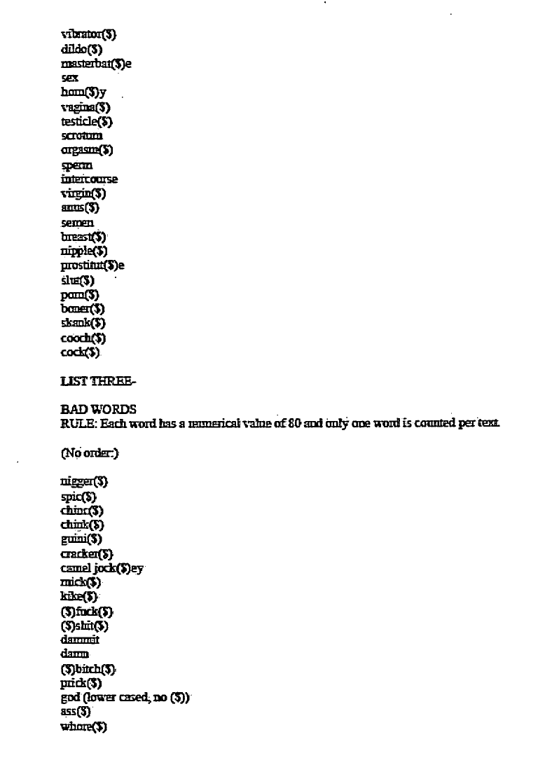

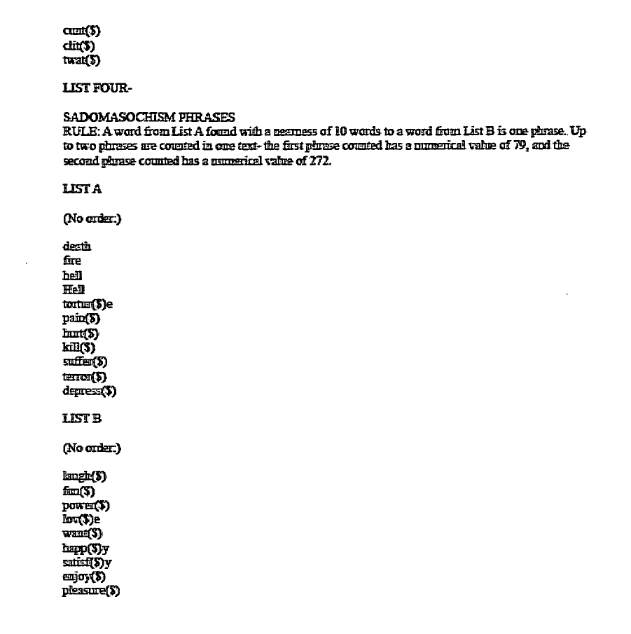

FIG. 10—The key words and key phrases used for each genre of book rated, based on separate lists for each genre and the rules, or criteria, used for assigning numerical values to groups and sets of key words and key phrases.

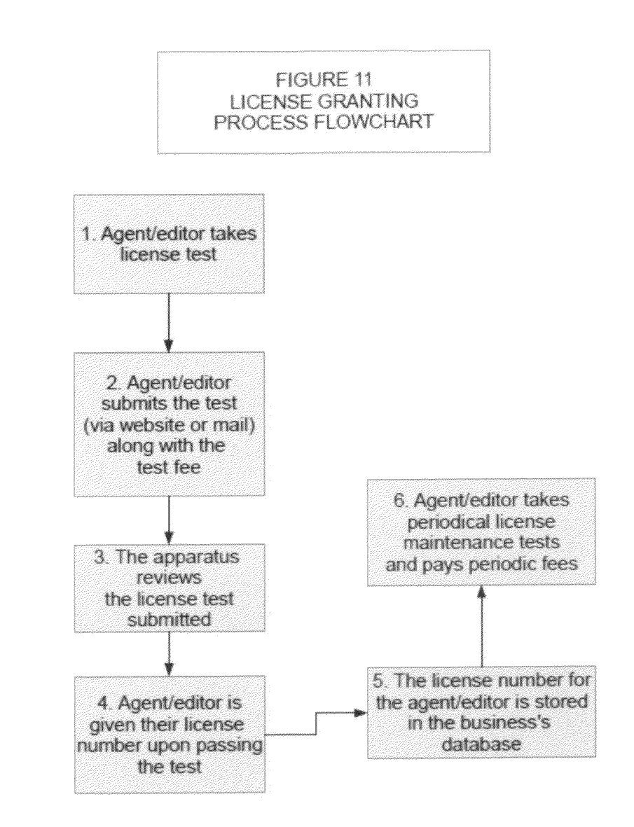

FIG. 11—The overall steps involved in the granting of a license to an individual for the legal right to use this patent's processes.

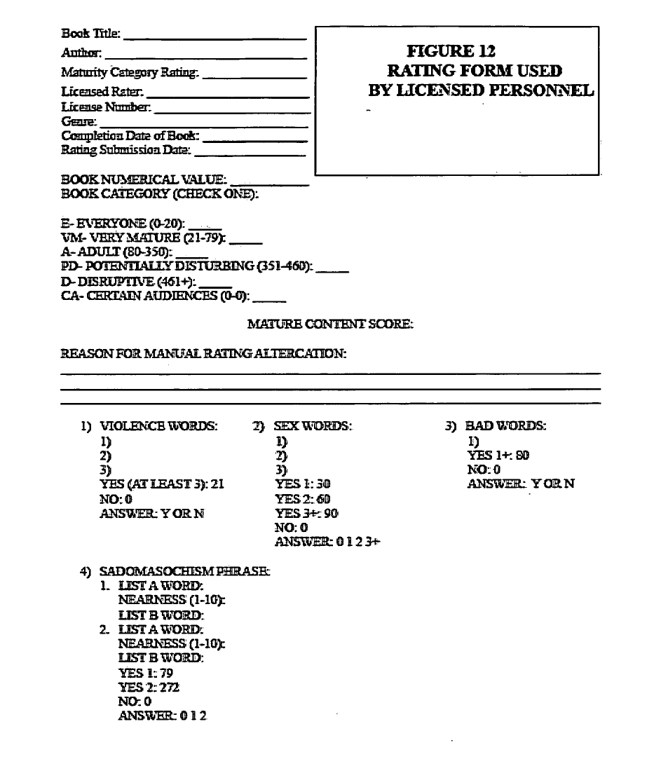

FIG. 12—The form used by licensed individuals to rate a book based on content maturity level if done manually.

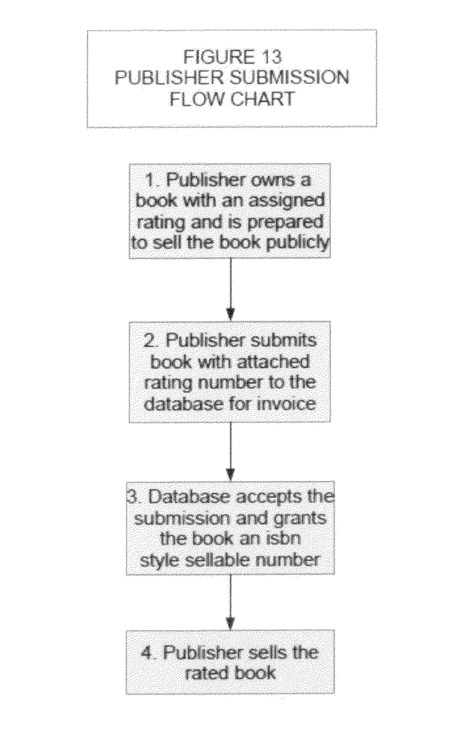

FIG. 13—An overview of how the publisher of a book, the apparatus and the databank collaborate to use a maturity rating for public distribution.

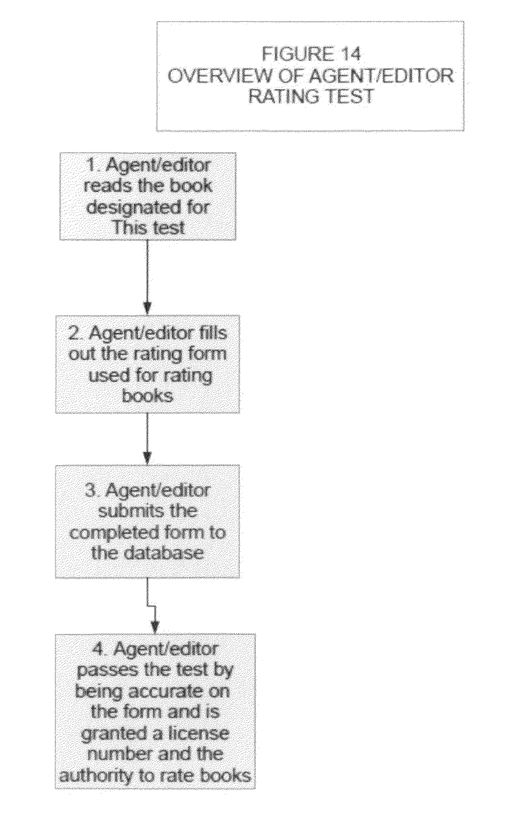

FIG. 14—Shows the step-by-step process of how an individual is granted a license by the databank for the right to give a book a maturity rating, involving taking a test.

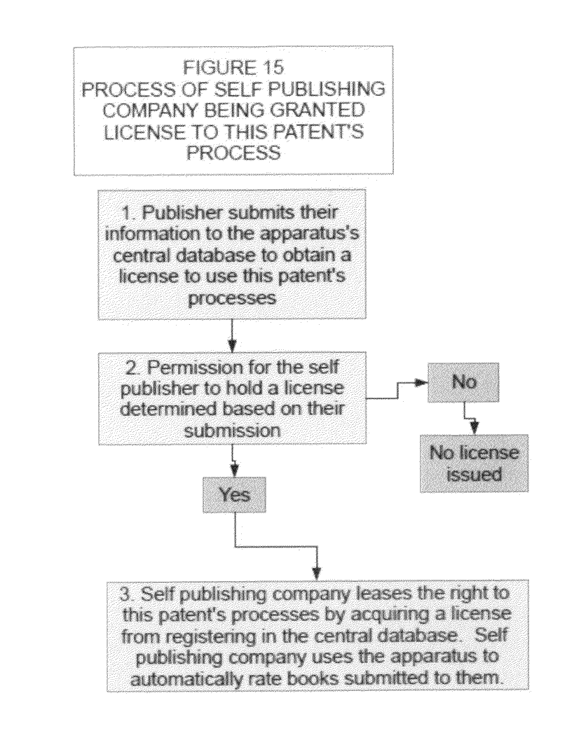

FIG. 15—Shows the process of granting a self publishing company the right to use apparatus's processes to rate the books they publish.

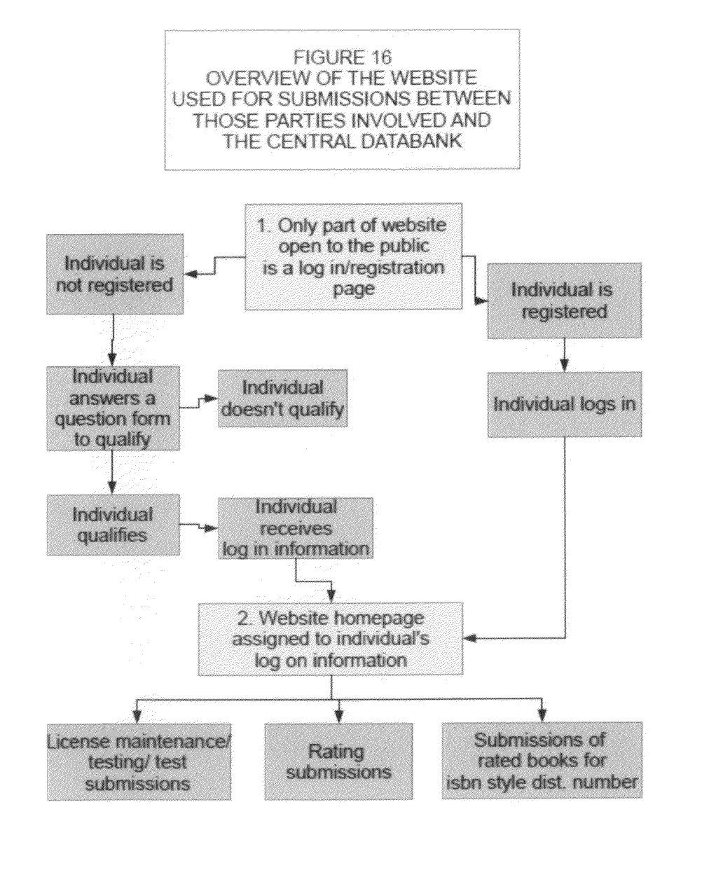

FIG. 16—A quick overview of the type of website and style of configuration used by the databank for licensed individuals to submit the ratings they assign to books for a rating confirmation and for the fees and testing for rating license maintenance.

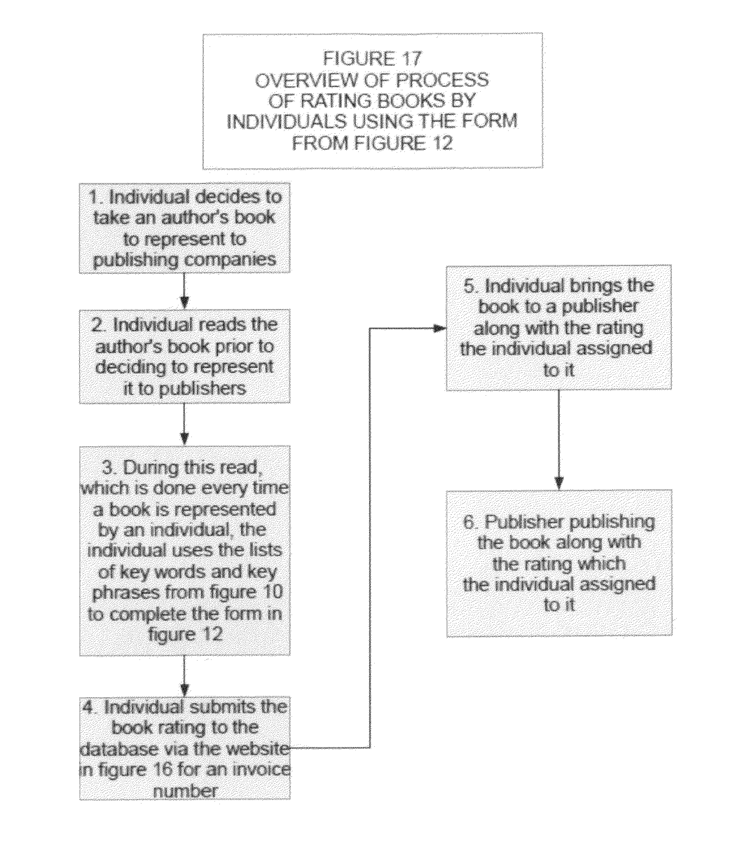

FIG. 17—The overall process carried out by an individual using the form in FIG. 12 to assign ratings to books, without adding any time or effort to their already existent work schedule.

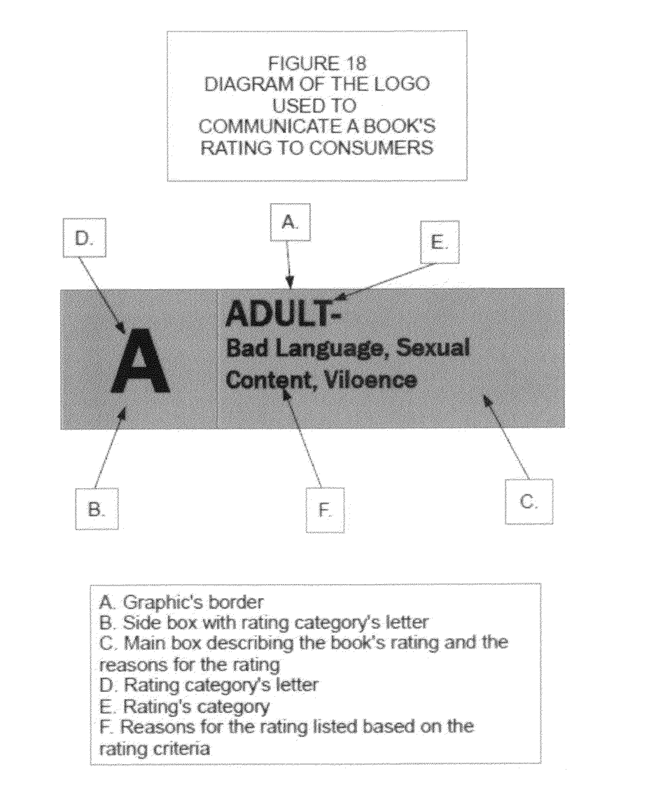

FIG. 18—A diagram showing the different components of the maturity rating graphics used by the apparatus to communicate the book's rating.

TITLE I: Overall Process For Software Rating System

One embodiment of a five part activities process (FIG. 2.) which involves all apparatus software (A.1.), partly apparatus software and partly retail website software (FIG. 3.), or all retail website software developed and overseen by apparatus software (FIG. 4.), or a combination of apparatus software, retail website software, and third party banking institution software (FIG. 5.);which carries out these processes in five separate steps in chronological order: Part One (A.2.) is the process of Connect and Scan Library (A.3.); Part Two (A.4.) is the process of Connect and Scan Items Lists (Information Categorizing Program) (A.5.); Part Three (A.6.) is the process of Make Label of Each Item A Graphic (Automatic Labeling Program) (A.7.); Part Four (A.8.) is the process of Record Each Time An Item Is Sold With Its Label (Financial Transaction Program) (A.9.); Part Five (A.10.) is the process of Security System (Security Program) (A.11.) and carries out, by computerized machines, Overall Process For Rating System Performed During the Publishing Process (FIG. 7.). Every book that the apparatus rates automatically will be recorded in a central database and will be assigned an invoice number (A.12.).

TITLE II: Overall Process For Rating System Performed During the Publishing Process

One portion of a multi-step publication process (FIG. 8.), which allows books to be rated by an individual (B.1.) at no extra cost of time or energy (FIG. 7.: A.5.(1.) through (A.5.(3.)), which is done by individuals who carry a license issued to them granting the right to this patent's processes. The individual assigns the book a maturity rating using the form in. FIG. 12 during the first read through of the book to determine if they will represent the author's book to publishers (B.2.), thus not requiring any further time or energy than they use in their jobs without rating books. The individual submits the book's maturity rating to the database in return for the invoice number (B.3.). Once the book is entered into contracts for distribution with a publisher, the publisher submits the book along with the invoice number to the database via a restricted website for the right to use the rating derived by this patent's process during distribution (B.4.).

TITLE III: Software Automatic Rating Process

This process of rating books for maturity level is shown in full detail in (FIG. 7.). The apparatus uses different programs to accomplish each step of assigning a rating. The first type of program allows the apparatus's search engine to connect and communicate with the text files for each book in an eBook library (A.2.), (A.3.), (A.5.(1.)). Once the apparatus is simultaneously connected to each book's text file, it uses a search engine to scan every word in each book for key words and key phrases, which determine the maturity level of each book (A.5.(1.)), (A.5.(2.)), (A.5.(3.)).

The software uses rules to determine the value of each key word and key phrase for their different lists (A.5.(2.)). Each list of key words and key phrases has its own set of rules (FIG. 10). Using the rules, a separate program uses the results from the search engine to assign each book a numerical value based on the total numerical values of each key word and key phrase found in the book as determined by those key words and key phrases' rules (A.5.(2.)).

The final software process involves other programs, which then match the maturity rating category logo representing the book's maturity level for each book (A.6.). The logos are assigned to the range of numerical values each maturity level includes (A.4.). The book's assigned logo is then displayed by a different program in the online store's library along with the other book details, with marketing purposes of attracting more readers to each rated book (A.7.).

NOTE—The numerical ranges are shown in FIG. 7 and FIG. 12.

TITLE IV: Graphics For Each Rating Category

The graphics for each rating category are a rectangular, uniform format which displays the specific information for each category (FIG. 18). These graphic logos are listed in the eBook library along with each book's book details or along the bottom of a book's back cover if it is a physically printed book.

TITLE V: Automatic Banking System Software to Take Commission on Books Sold With Rating

The apparatus that provides the rating process will involve the function of receiving commission on each rating used in the sale of the book with the philosophy that it was purchased along with the book. This function is carried out either by the apparatus (FIG. 7 A.8., A.9.), or merchant software provided by a banking institution and/or merchant software provided by the eBook library's store with security software oversight provided by the apparatus (FIG. 7 A.10., A.11.).

TITLE VI: Licensing Process

The process of rating literature is performed by an individual or separate entity that has been granted the permission to use this patent's processes by receiving a license to do so. Individuals that present an author's book to a publisher for publication will rate the book prior to presenting it by being granted a license to do so for having passed the test for the license, paying license fees, using the rating format along with the review checklist if done manually, or submit the book to their personal copy of the apparatus and submitting each book's rating to the database for an invoice number (FIG. 11.). The process of rating literature by a self publishing company will be carried out by a licensed self publishing company using the apparatus to automatically rate the books submitted electronically to the self publishing company during that submission.

TITLE VII: Maturity Rating Review Checklist

The individual review checklist is every list of key words and key phrases (FIG. 10.). These lists are used by the individual during the initial read through of a book they are presenting to a publisher to complete the rating form (FIG. 12.). The rating criteria allows for an accurate rating for a book including possible mistakes made by the individual according to the numerical ranges used for each category (A.4.),

TITLE VIII: Submission Process Involving Publisher

The process of a book being submitted to the database for its rating involves both the publisher and the individual who rated the book (FIG. 8.). The individual submits a book to the database, with the rating the individual assigns to the book, for an invoice number prior to the book being sold with the rating. Once the book is prepared for sale by the publisher, the publisher submits the rated book to the database for the right to sell a book's rating along with the book.

TITLE IX: Book Rating Recording Database System, Including Database of Licensed Individuals With Automatic Renewal Request

There is a database of all literary industry involvement with literature ratings. This involvement includes, but is not limited to, the individuals carrying out the process of rating books, each individual's standing with the database per the licensing system, each book sold with a rating either on a commission basis as the eBook software functions or based on the publisher system, and the rating activity of all self publishing companies which are assigned the right to rate literature by receiving a license. Every book rated by a self publishing company will also automatically be recorded and assigned a rating number by the database (A.12.).

TITLE X: Overview of the Test Taken by Individuals to be Granted A License For A Set Period of Time

The test taken by individuals to be granted a license for the right to rate books involves the act of rating a book using the form in FIG. 12. This form will be filled out by the individual, submitted to the database via the business website, and the individual will be granted a license based on the test, paying the fees for it, and other business standards such as clients and a publisher vouching for them. The test is using the exact format used to rate all books for one particular book that is chosen for the test, which is currently available.

TITLE XI: Process For Licensing Self Publishing Companies to Represent Their Customer's Books With Ratings

A self publishing company works by using a website for authors to submit their books to in exchange for paying the fees the company charges. Once the book is submitted the self publishing company works with the author to design the book's physical appearance, lists the book for sale on the company's network of distributor websites, and prints on demand the total number of books the author or readers purchase. Some companies also do a minor marketing campaign, which the author pays for.

The two main differences between a self publishing company and a publisher is: 1) The book is submitted electronically without any human approval necessary to get the book published; 2) The marketing costs are paid for by the author rather than the publisher. A traditional publisher is basically a bank with media relationships, using their own capital to pay for an author's book's marketing campaign and then receiving a return on investment from the sales income of the book.

Therefore, since all books are submitted electronically by text formats, the rating process is carried out the same way as with eBooks using the same apparatus (FIG. 15.). Every time an author submits a book to the self publishing company, the apparatus gives the book a rating, and the graphic for the book's maturity category is attached to the book details and is recorded by both the database for invoice number and the self publishing company for use to display to the customers on the book's back cover or in an eBook library.

This use of the apparatus by a self publishing company is compensated financially depending on business agreements and requirements.

TITLE XII: Overview of Website Used For Rating Submission Process From Licensed Individuals to the Business and For License Maintenance and Testing

The communication between the database and individuals is via a restricted website (FIG. 16.). There is no human interaction in order for an individual to receive a license to rate literature. The website is not open to the public and is only used for verifying an individual's right to rate literature. The requirements of holding a license to use this patent's processes are passing a test and remaining in good standing with the database's system. If an individual loses their good standing with the database, an automatic software process carried out by the apparatus used in the databank sends the individual warning notices and automatically revokes the license after a certain period of time.

TITLE XIII: Overview of Review Process Carried Out by Licensed Individuals by An Established Format Used For Each Book

An individual reviews a book to rate it while reading the book for the first time (FIG. 17.). The review is counting the number of key words and key phrases from the Individual Rating Review Checklist (TITLE VII FIG. 10), using the rules and criteria in the form from FIG. 12. The key words and key phrases found in the text of the book are counted up to the amount needed in the form based on the rating rules.

Then the individual uses the form from FIG. 12 to assign the book its maturity category based on a numerical value conceived by the numerical values of the key words and key phrases found in the book. The key words and key phrases have numerical values from the rules and criteria in the form from FIG. 12.

TITLE XIV: Process Overview of Select Rating Submissions of Book Ratings By Licensed Individuals

Provided, for some reason there is a need for book ratings to be altered from a low maturity rating up to the rating of ‘Adult’ (FIG. 1.) by an individual that rates the book, because of mature content which is not related to the exact language in the book, the individual will submit the rating of ‘Adult’ on the form in FIG. 12 along with a written statement explaining their reasons for the altered rating of ‘Adult’ along with the rating, to the database, and will receive an invoice number for the book's rating of ‘Adult’. This process is only available for altering a rating to ‘Adult’ from a lower category or for altering a rating to ‘Disruptive’ from a lower category. In order for a book to receive the rating of ‘Certain Audiences’, the rating must be agreed upon by one licensed individual, a publisher, and the database of ratings prior to the book receiving the rating. The rating of ‘Certain Audiences’ gives the publisher the authority to choose which audiences have access to the book. The individual is then responsible for the altered rating being accurate to the database, the distributor, and themselves. This process is a main reason for the issuing of licenses to individuals who display their ability to be accurate.

I claim:

1. A process for assigning a maturity rating to a book referring to the book's intended audience's maturity level using an apparatus comprising of multi-step software wherein the content of the book is scanned by a search engine, which interoperably assigns that book a maturity level prior to adding the book to the listings of a central database of invoiced book ratings organized based on book ratings, and then displaying the book's maturity rating as a graphic logo along with the book details in an online library belonging to a retail website by means for reviewing the language, content, nature, themes and relevant material contained within the book.

2. The apparatus from claim 1 further including ratings performed simultaneously on many books at once by scanning an entire listing of books thereby assigning said books their ratings.

3. The apparatus from claim 1 further including automatically recording ratings in a stand alone central database organized per book rating submission.

4. The apparatus from claim 1 further including an established format of unilateral criteria from a constitutional creed.

5. The process in accordance with claim 1 further including the conceived by said process displayed per book to consumers during advertising, sale, inventory, and marketing.

6. The apparatus from claim 1 further including a search through the text of the book for certain key words and key phrases with means of classifying those key words and key phrases as a certain maturity level.

6. (canceled)

7. The apparatus of claim 6 wherein the method used has rules which determine how to gauge a level of maturity based on minimums, maximums, and combinations of the key words and key phrases found in the book's text from the search performed in claim 6.

8. The apparatus of claim 6 further including a numerical scale such that the messages communicated via the book's text an ambivalent existence of numeral and linguistic mediums providing the measurement of the numeral orientation during said process of scanning the content of a book.

9. The apparatus of claim 6 wherein the maturity level that the key words and key phrases is classified as is disposed of on a numerical value scale.

10. The expression of each book's maturity level with an explicit graphic logo displaying maturity rating along with content description to the public, inherently interconnected in the unilateral criteria of maturity level assessment.

11. A process carried out by an individual and a publishing company to assign maturity ratings to books with the intent of selling rated books to consumers whereby the processes are performed manually such that the recording of a book's text's indicators of maturity level is in a provided template to determine the book's maturity rating such that current normal job duties of reading each book sold prior to publication includes this manual method in the same process.

12. The said template from claim 11 further including rules to assign numerical values to the key words and key phrases found in a book, during the first read through of each book rated, from lists of key words and key phrases included in said template in order to assign a numerical value to the book.

13. The method from claim 11 further including that the only individuals who perform said process of rating books are those who have been granted the right to this patent's processes by receiving license based on testing.

14. The method from claim 11 whereby it is carried out by many individuals of similar stature in the publishing industry simultaneously and singularly.

15. The method in accordance to claim 11 whereby an individual performs the rating during the initial read through of a book from an author prior to representing the book to publishers.

16. The method in accordance to claim 11 whereby said process of an individual assigning a book a maturity rating is disposed prior to a publisher receiving said book.

17. The method from claim 11 whereby each book rated is submitted to a central database in exchange for an invoice number prior to the distribution of the rated book to consumers.

18. The process in accordance to claim 1 wherein self publishing companies use said apparatus to grant their books a rating once said self publishing companies receive permission to use said apparatus.
